(19) United States
(12) Patent Application Publication
(10) Pub. No.: US 2026/0090550 A1
(43) Pub. Date: Apr. 2, 2026

(54) INTESTINAL FLUSHER ASSEMBLY

(71) Applicant: Superior Industrial Mechanical, Inc., Sioux City, IA (US)

(72) Inventors: Aaron Shaeffer, Sioux City, IA (US); Gabe Rohan, Sioux City, IA (US)

(21) Appl. No.: 19/341,597

(22) Filed: Sep. 26, 2025

Related U.S. Application Data
(60) Provisional application No. 63/700,061, filed on Sep. 27, 2024.

(51) Int. Cl. A22C 17/16

(52) U.S. Cl. CPC A22C 17/16

(57) ABSTRACT

An intestine flusher assembly for internally and externally cleaning an intestine. The assembly includes a central tube having a central tube having a first end and an opposing second end, where the first end has a forward-facing nozzle for discharging water to dislodge fecal matter within the intestine, and rear-facing ports for discharging water to simultaneously push the intestine along the central tube and clean the interior of the intestine. The assembly also includes also includes spreader bars for spreading the intestine as the intestine is moved along the central tube. The assembly further includes spray bars configured to oscillate while spraying to wash the exterior of the intestine.

### BACKGROUND

Animal intestines, such as pig intestines, are consumed as food. Prior to consumption, the animal intestines are cleaned.

### DRAWINGS

The Detailed Description is described with reference to the accompanying figures. Any dimensions included in the accompanying figures are provided by way of example only and are not meant to limit the present disclosure.

FIG. 1 is a front elevation view of an intestine flusher assembly in accordance with example embodiments of the present disclosure.

FIG. 2 is a left side elevation view of the intestine flusher assembly illustrated in FIG. 1.

FIG. 3 is a partial cross-sectional left side elevation view A-A of the intestine flusher assembly illustrated in FIG. 1.

FIG. 4 is a right side elevation view of the intestine flusher assembly illustrated in FIG. 1.

FIG. 5 is a partial cross-sectional right side elevation view B-B of the intestine flusher assembly illustrated in FIG. 1.

FIG. 6 is a rear elevation view of the intestine flusher assembly illustrated in FIG. 1.

FIG. 7 is a top plan view of the intestine flusher assembly illustrated in FIG. 1.

FIG. 8 is a bottom plan view of the intestine flusher assembly illustrated in FIG. 1.

FIG. 9 is a partial cross-sectional perspective view C-C of the intestine flusher assembly illustrated in FIG. 1.

FIG. 10 is a perspective view of an intestine flusher assembly in accordance with example embodiments of the present disclosure.

FIG. 11 is a front elevation view of the intestine flusher assembly illustrated in FIG. 10.

FIG. 12 is a partial cross-sectional left side elevation view D-D of the intestine flusher assembly illustrated in FIG. 10.

FIG. 13 is a top plan view of the intestine flusher assembly illustrated in FIG. 10.

FIG. 14 is a left side elevation view of the intestine flusher assembly illustrated in FIG. 10.

FIG. 15 is another left side elevation view of the intestine flusher assembly illustrated in FIG. 10.

FIG. 16 is a right side elevation view of the intestine flusher assembly illustrated in FIG. 10.

FIG. 17 is a partial cross-sectional view E-E of the intestine flusher assembly illustrated in FIG. 10.

FIG. 18 is another partial cross-sectional view F-F of the intestine flusher assembly illustrated in FIG. 10.

FIG. 19 is a further partial cross-sectional view G-G of the intestine flusher assembly illustrated in FIG. 10.

FIG. 20 is another partial cross-sectional view H-H of the intestine flusher assembly illustrated in FIG. 10.

FIG. 21 is a perspective view illustrating a frame for an intestine flusher assembly, such as the intestine flusher assembly illustrated in FIG. 10, in accordance with example embodiments of the present disclosure.

FIG. 22 is a perspective view illustrating a wash cabinet for an intestine flusher assembly, such as the intestine flusher assembly illustrated in FIG. 10, in accordance with example embodiments of the present disclosure.

FIG. 23 is a perspective view illustrating a motor mount for an intestine flusher assembly, such as the intestine flusher assembly illustrated in FIG. 10, in accordance with example embodiments of the present disclosure.

FIG. 24 is a perspective view illustrating a spray bar assembly including a central tube and spreader bars for an intestine flusher assembly, such as the intestine flusher assembly illustrated in FIG. 10, in accordance with example embodiments of the present disclosure.

FIG. 25 is another perspective view of the spray bar assembly illustrated in FIG. 24.

FIG. 26 is a perspective view illustrating a spray bar weldment for an intestine flusher assembly, such as the intestine flusher assembly illustrated in FIG. 10, in accordance with example embodiments of the present disclosure.

FIG. 27 is a perspective view illustrating a spray bar arm weldment for an intestine flusher assembly, such as the intestine flusher assembly illustrated in FIG. 10, in accordance with example embodiments of the present disclosure.

FIG. 28 is a perspective view illustrating a spray bar arm spreader for an intestine flusher assembly, such as the intestine flusher assembly illustrated in FIG. 10, in accordance with example embodiments of the present disclosure.

FIG. 29 is a perspective view illustrating a water inlet header for an intestine flusher assembly, such as the intestine flusher assembly illustrated in FIG. 10, in accordance with example embodiments of the present disclosure.

FIG. 30 is a block schematic illustrating a fluid network for an intestine flusher assembly, such as the intestine flusher assembly illustrated in FIG. 10, in accordance with example embodiments of the present disclosure.

### DETAILED DESCRIPTION

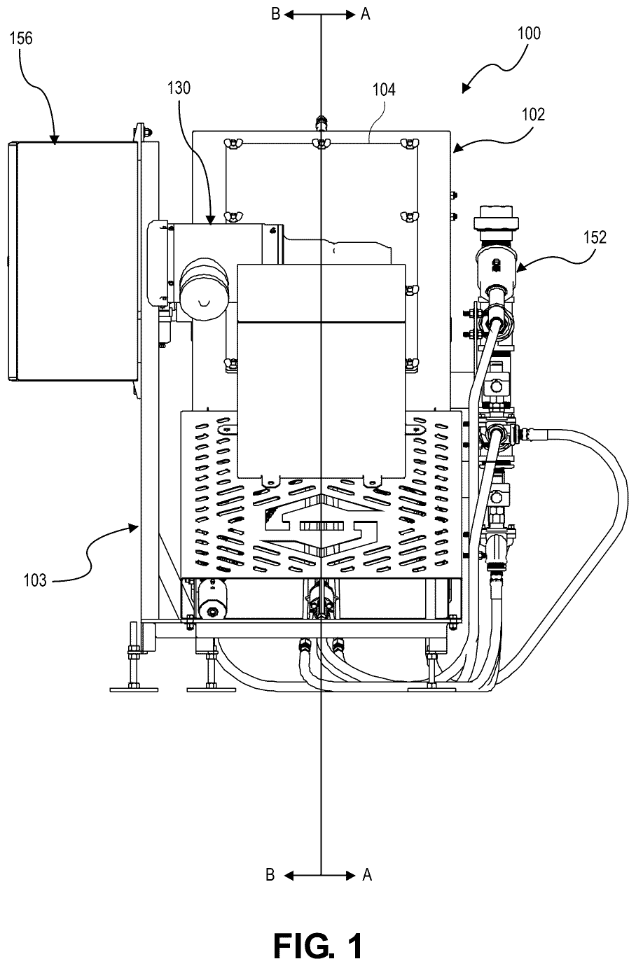

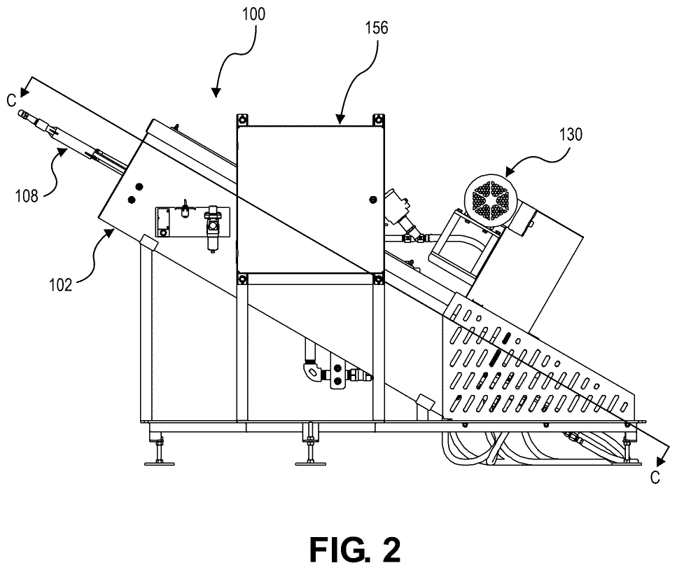

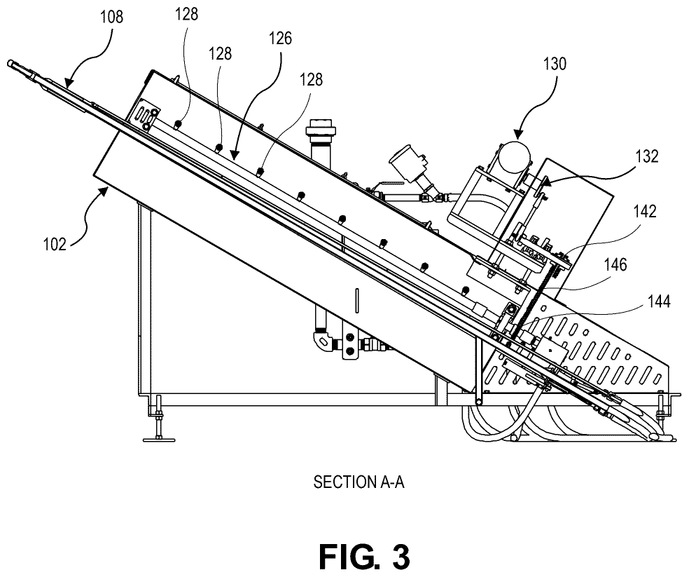

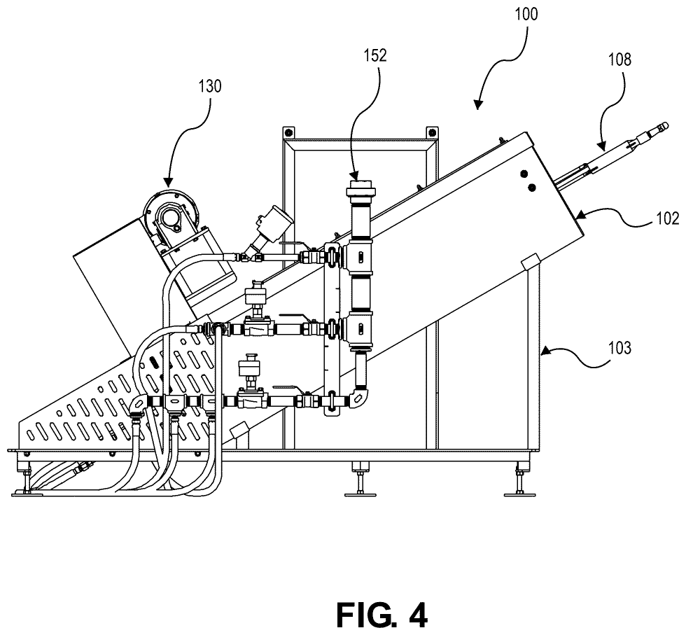

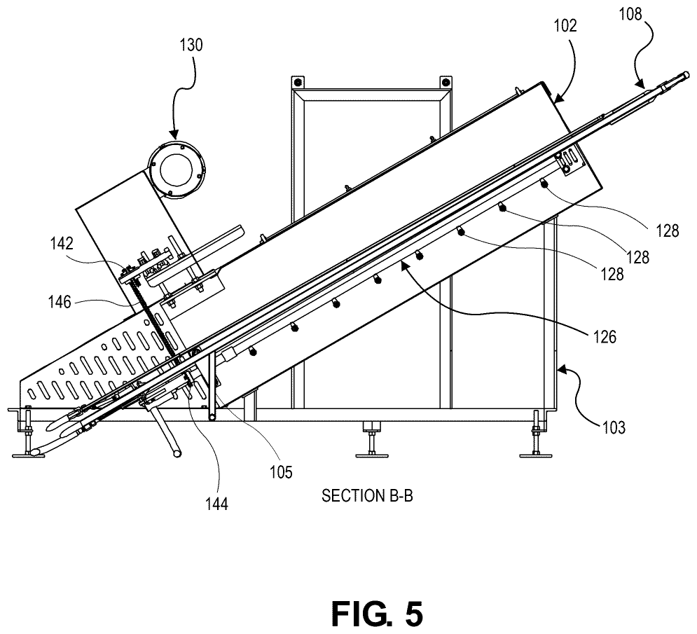

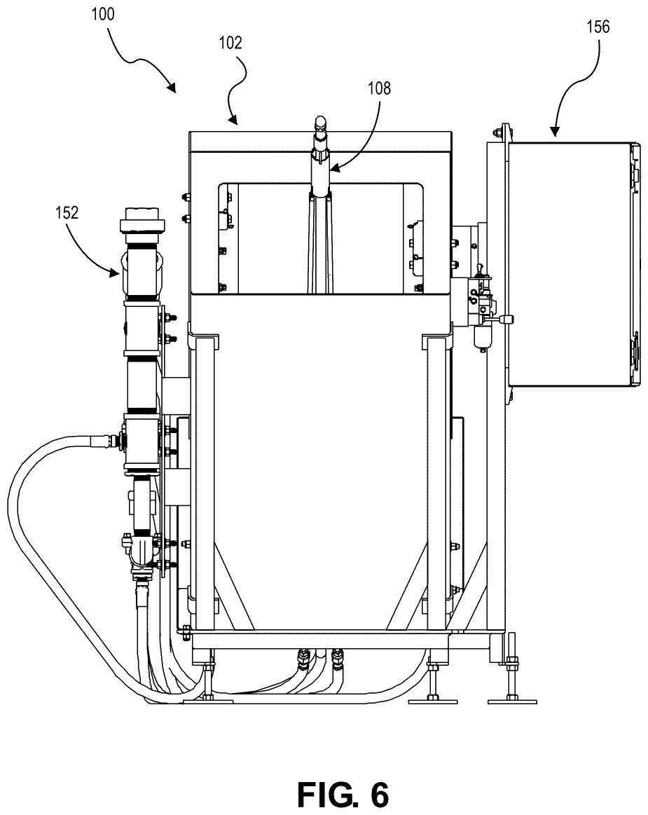

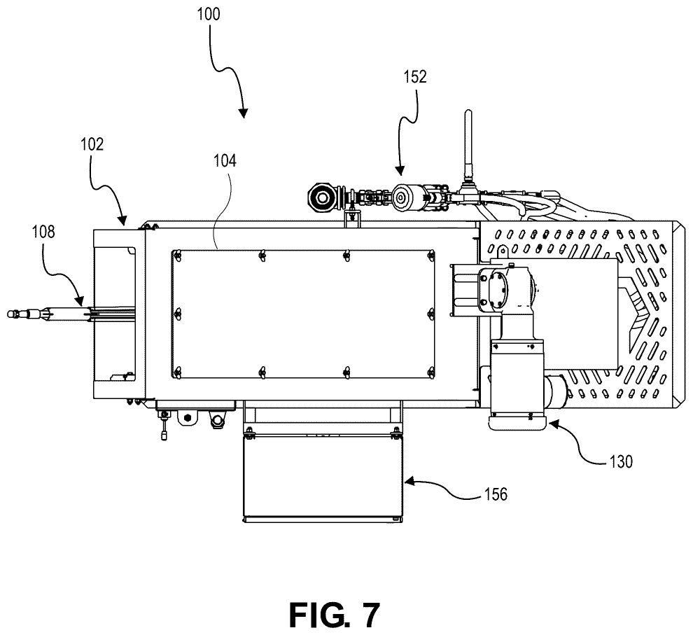

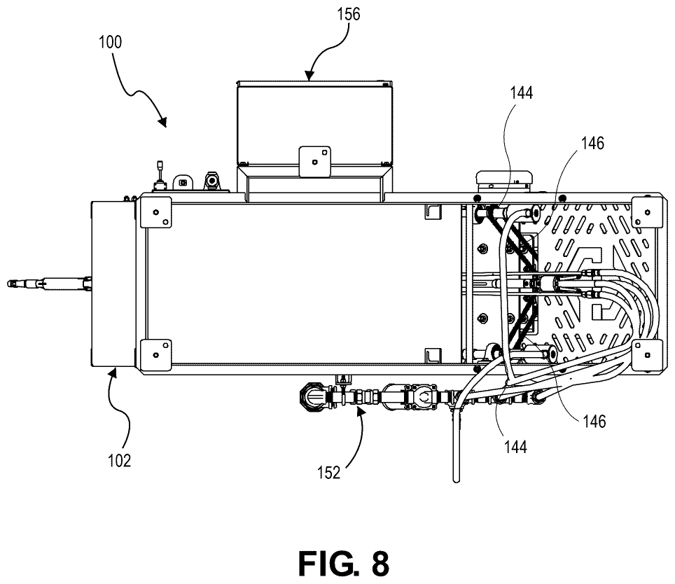

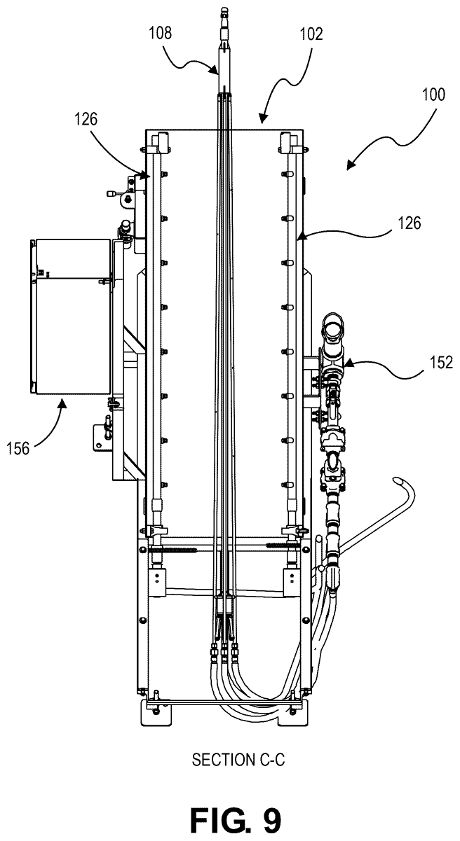

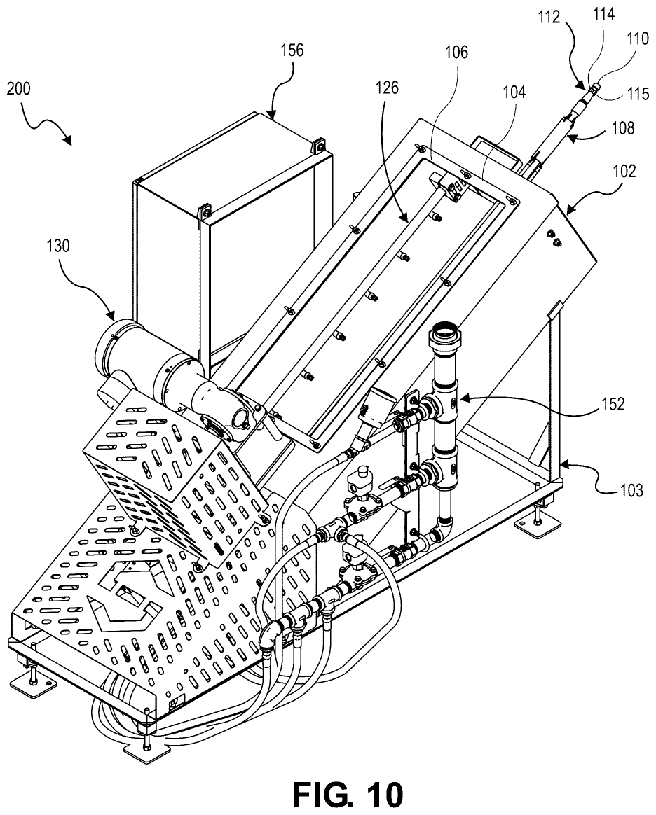

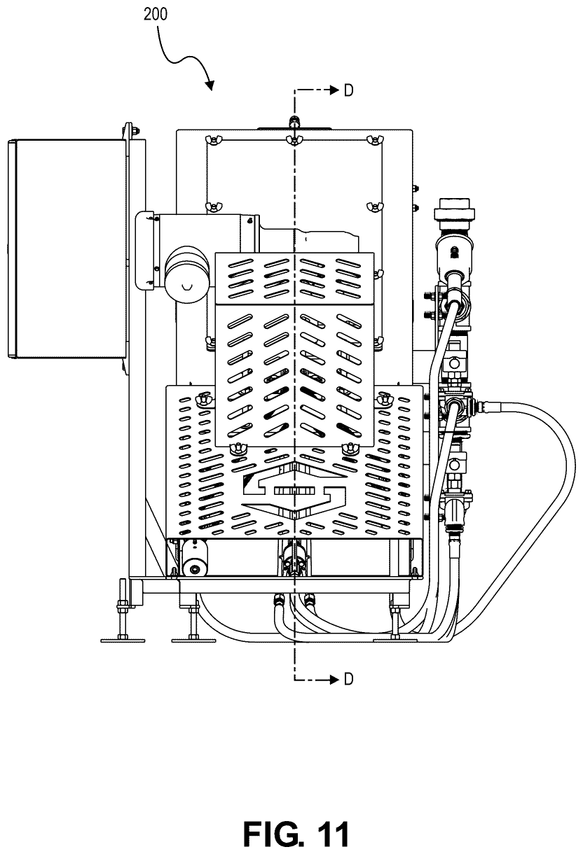

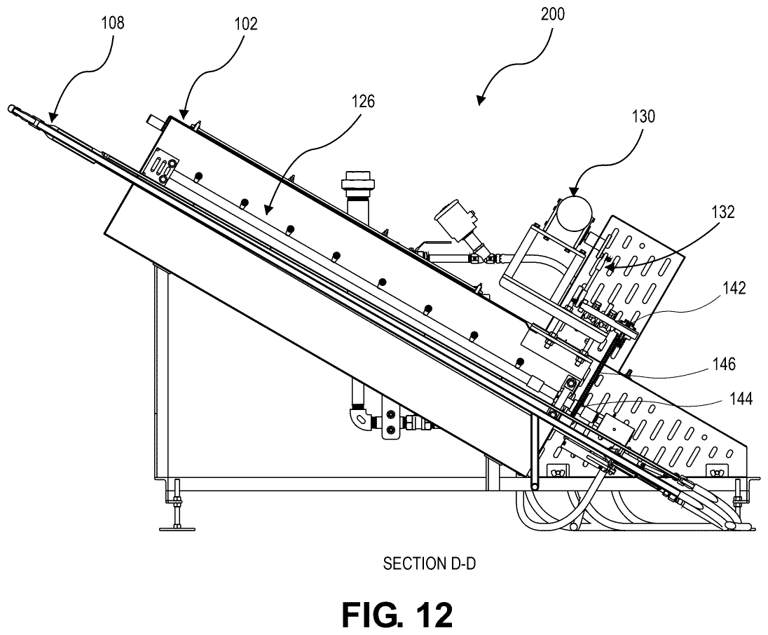

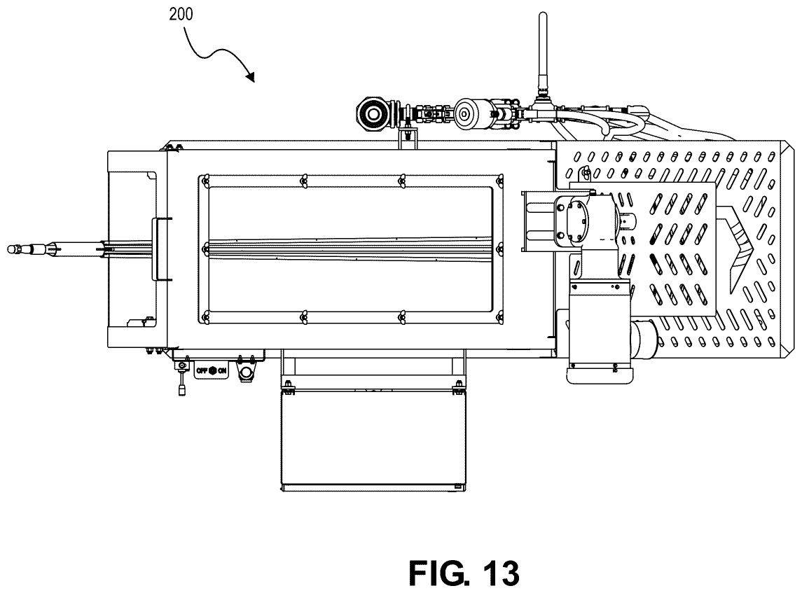

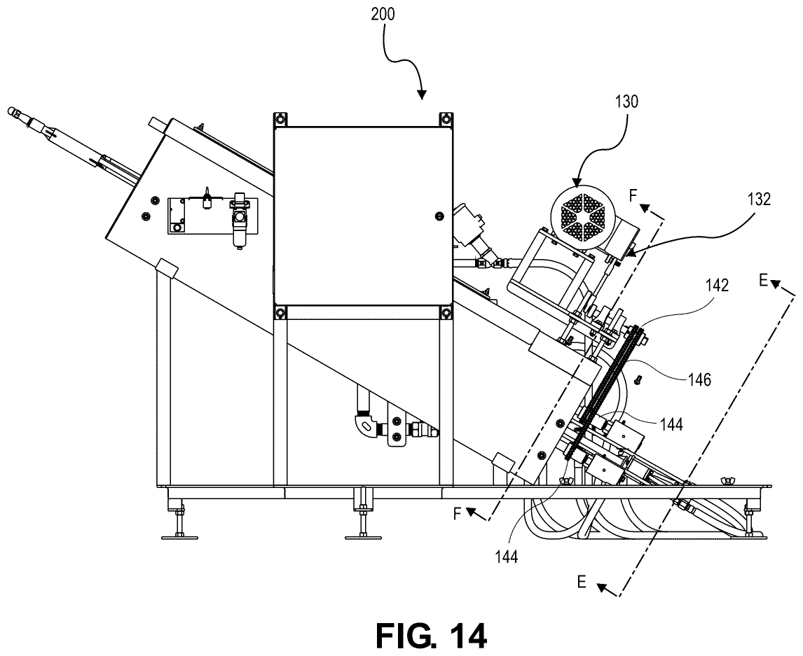

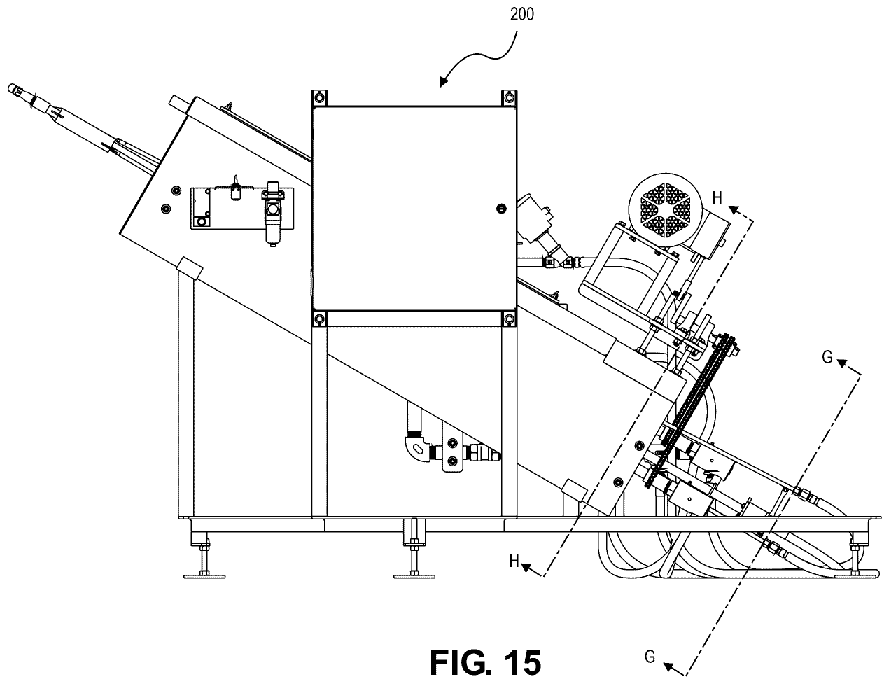

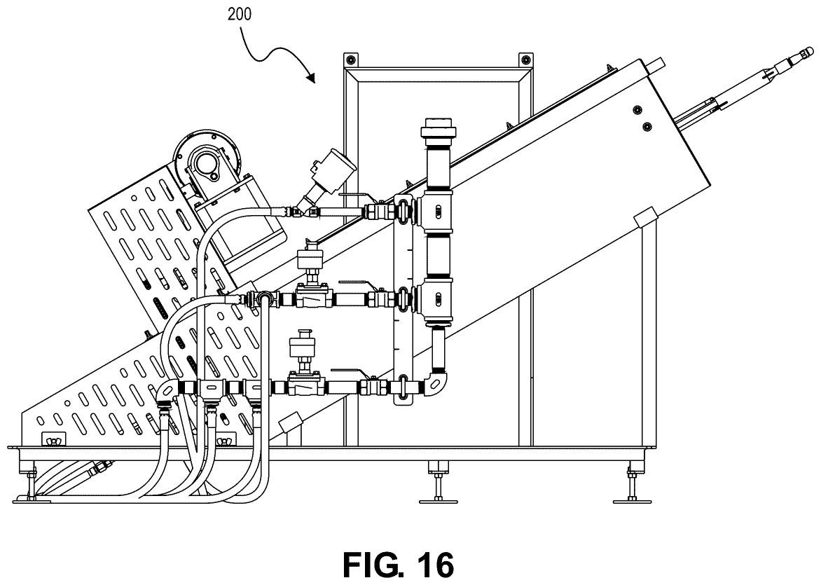

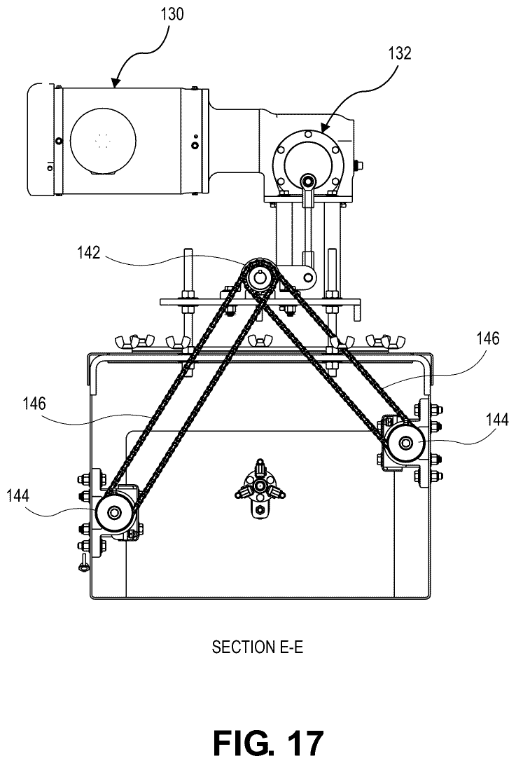

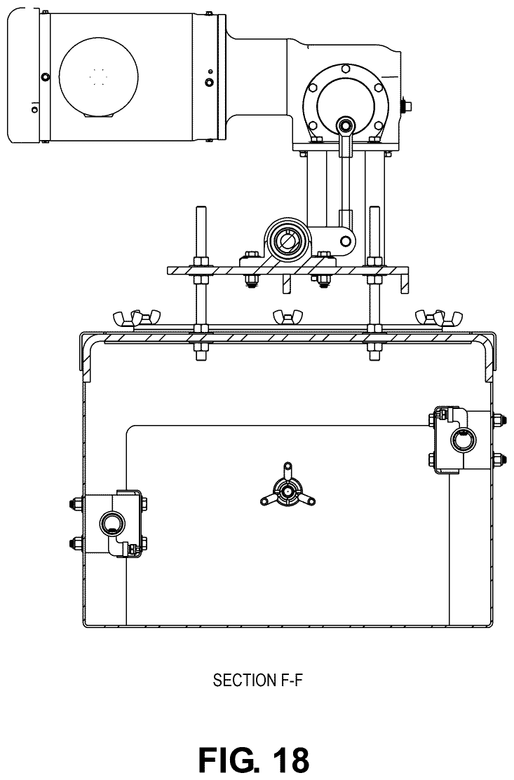

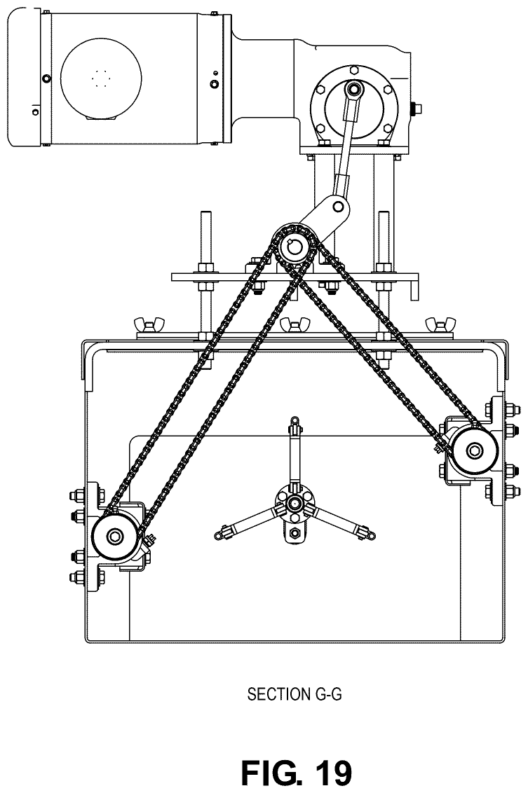

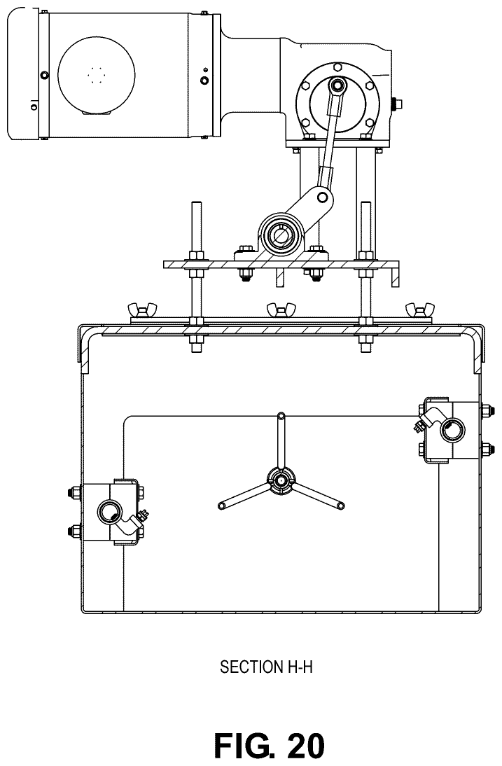

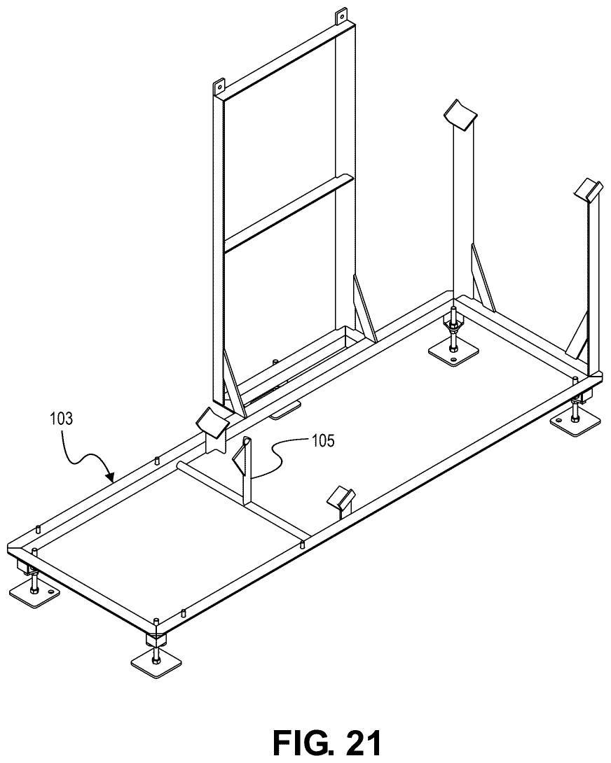

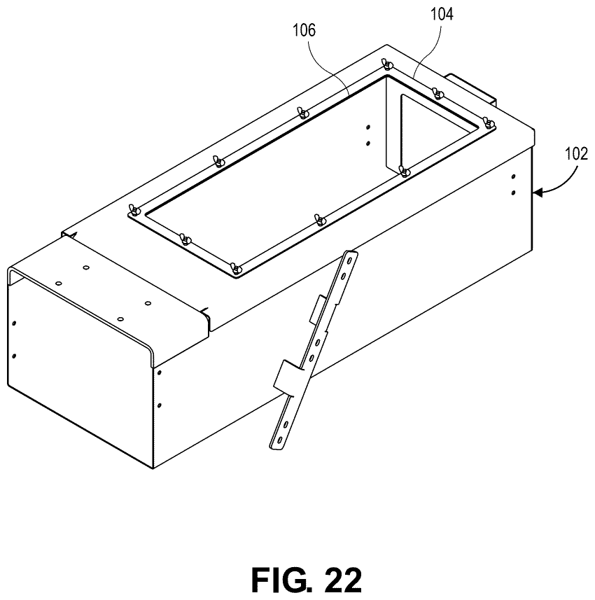

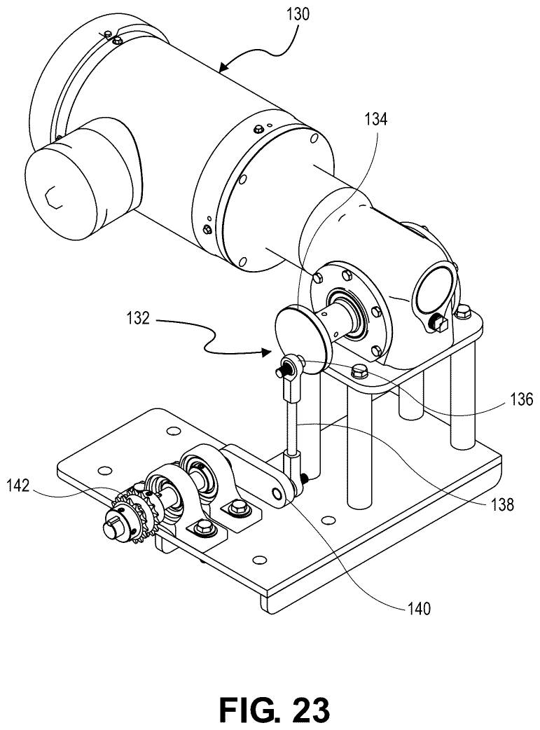

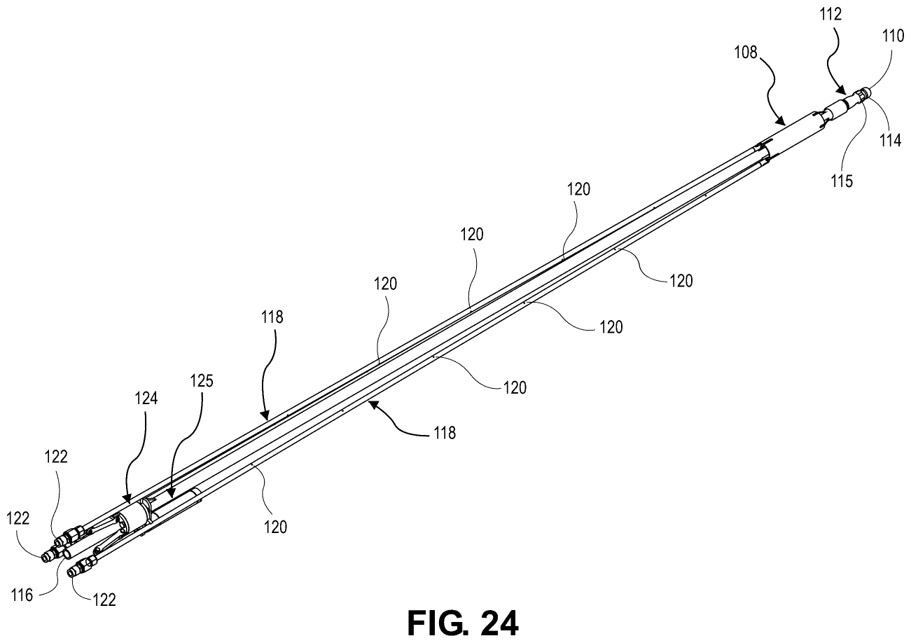

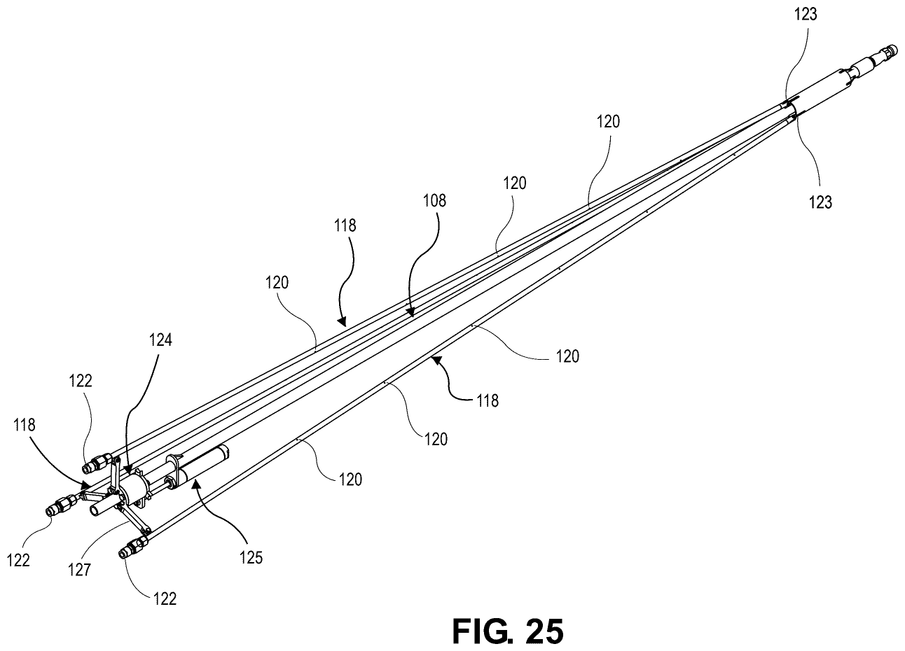

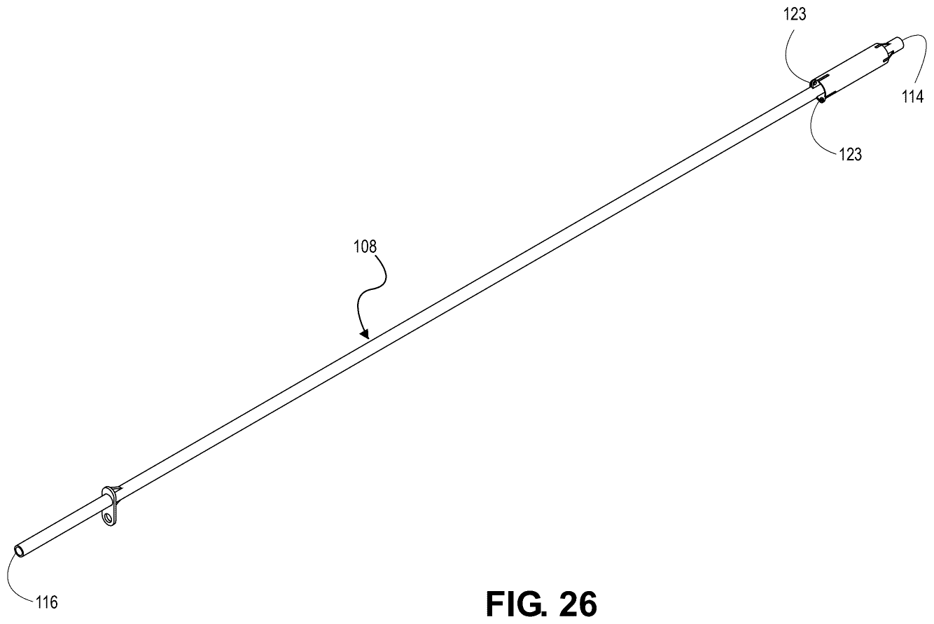

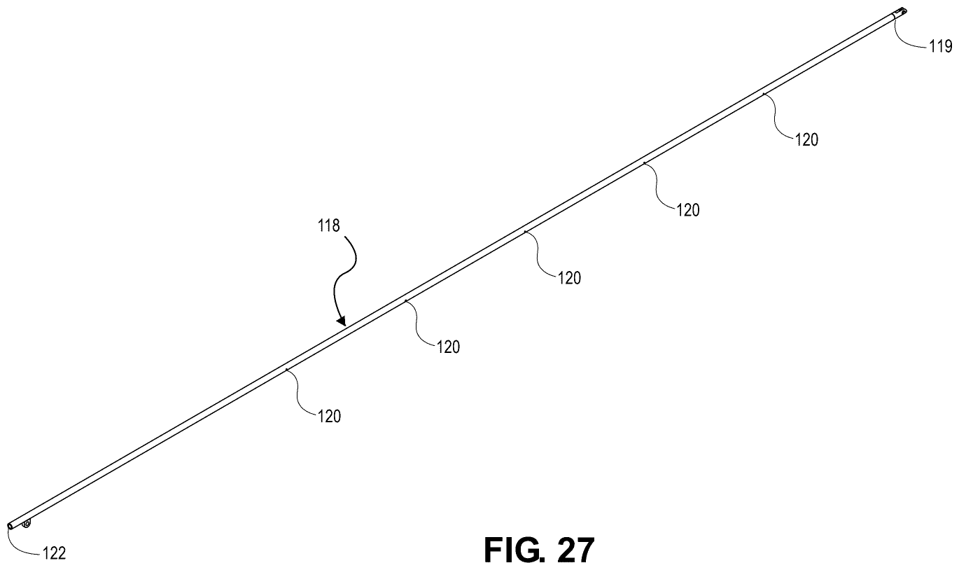

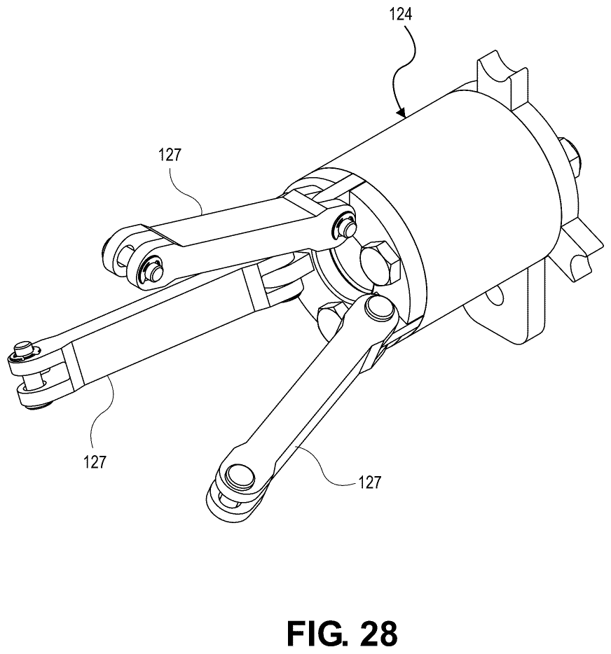

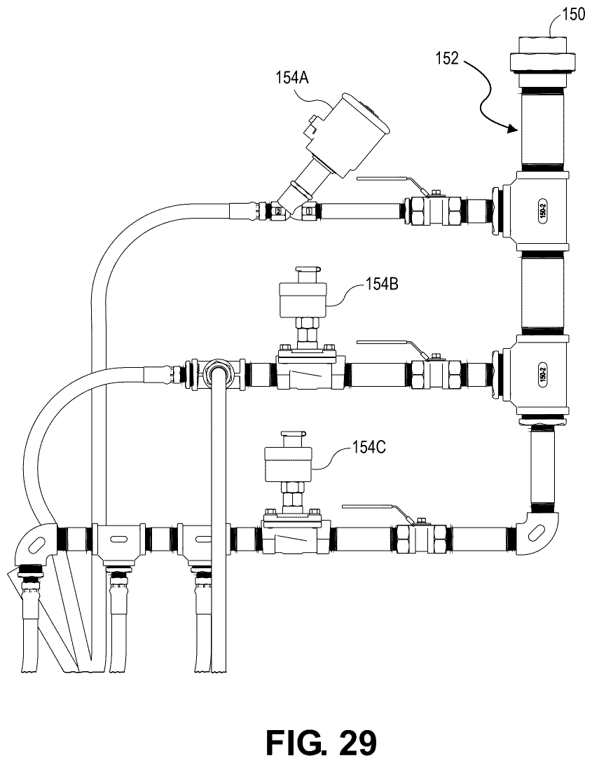

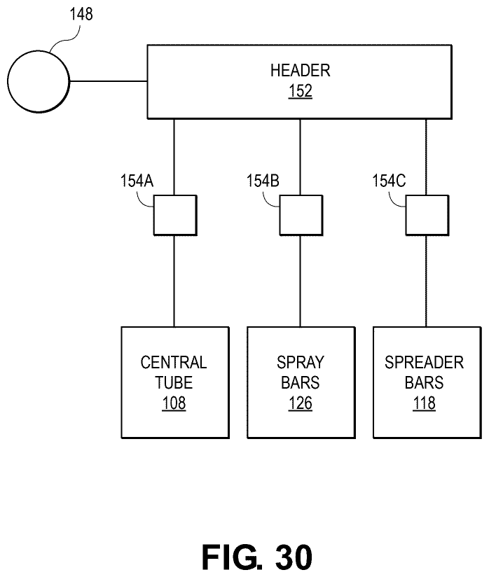

Referring generally to FIGS. 1 through 30 intestine flusher assemblies 100 and 200 are described. An intestine flusher assembly can be used for cleaning whole large intestines of animals, such as pigs. It is difficult to remove fecal matter from the intestines. The systems, techniques, and apparatus of the present disclosure can effectively and efficiently remove fecal matter from intestines. An intestine flusher assembly can both flush and wash the intestines.

The process of flushing and washing a whole large intestine typically involves removing the bung from the intestine and passing the intestine to a separator operator. Then, the large intestine is pulled apart and the mesentery material is removed. Typically, this process takes between about thirty (30) to forty-five (45) seconds. Next, a flusher operator locates the cecum of the intestine and cuts a hole large enough to fit a flusher. The operator then loads the intestine onto the flusher and cleans the interior and exterior of the intestine piece. The intestine piece is then removed from the flusher and passed to a trimming station. Typically, this process takes between about two (2) to five (5) minutes. Next, trimmer operators inspect and remove fat and fecal matter, which takes between about two (2) to (5) minutes. Then, the intestine material is transferred for chilling and boxing.

In accordance with the present disclosure, the intestine flusher assemblies 100 and 200 described herein can reduce the time for flushing and washing the intestine from the aforementioned two (2) and five (5) minutes to between about thirty (30) seconds and about one and one-half (1.5) minutes. Further, the time needed by the trimmer operators to inspect the intestine piece and remove fat and fecal matter can be reduced from two (2) and (5) minutes to between about thirty (30) seconds and about one and one-half (1.5) minutes.

The intestine flusher assemblies 100 and 200 can mechanically adapt to the irregular shapes and sizes of an intestine piece, e.g., adapting to varying diameters throughout the intestine from the cecum, where the small intestine joins the large intestine, through the colon. The intestine flusher assemblies 100 and 200 can efficiently and effectively clean fecal matter from both the interior and the exterior of the intestine. The intestine flusher assembly equipment can be enclosed in a housing 102 (e.g., wash cabinet) constructed of roll-formed 304 stainless steel or another material adapted for sanitary operation. In some embodiments, a removeable cover 104 for accessing the equipment can be provided in the cabinet. In some embodiments, the removable cover 104 can have a transparent (e.g., clear) viewport 106, which can be constructed of one-quarter inch (¼″) thick polycarbonate material and/or other transparent material. In general, the housing 102 is coupled to a frame 103.

The intestine flusher assemblies 100 and 200 can have a central tube 108 for loading an intestine piece. In embodiments, the central tube 108 is coupled to the frame 103 via a mounting bracket 105. In embodiments, a forward-facing water jet/jetter nozzle 110 can be positioned at a head 112 on a first end 114 of the central tube 108 onto which the intestine is loaded. The jetter nozzle 110 can be used to break up manure within the intestine as the intestine is loaded onto the central tube 108. In some embodiments, the jetter nozzle 110 has an orifice size of about sixty-five one-thousandths of an inch (0.065″). The head 112 of the central tube 108 can also include multiple (e.g., four, less than four, more than four) rear-facing water ports 115 that spray water backwards towards an opposing second end 116 of the central tube 108 to simultaneously push the intestine onto the central tube and clean the interior of the intestine by removing fecal matter.

The intestine flusher assemblies 100 and 200 can also have multiple (e.g., three, less than three, more than three) spreader bars 118 to spread the intestine as it is moved around the central tube 108. Each one of the spreader bars 118 includes a first end 119 and a second end 122, and can be positioned adjacent to the central tube 108 and can include apertures 120 for spraying water into the interior of the intestine to clean fecal matter from the interior of the intestine piece. In embodiments, the central tube 108 includes a plurality of hinges 123 that couple to each first end 119 of the spreader bars 118.

Water usage for the central tube 108 and the spreader bars 118 may be about fifteen gallons per minute (15 gpm) at about ninety pounds per square inch gauge pressure (90 psig). In some embodiments, the spreader bars 118 can have multiple one-sixteenth inch ( 1/16″) apertures 120 (i.e., holes) arranged along the length of each spreader bar 118 (e.g., in a row), with water fed into respective first ends 122 of the spreader bars 118 to be ejected outwardly from the apertures 120 into the intestine. The spreader bars 118 can be cylinder driven to spread outwardly and stretch the intestine as it is fed around the central tube 108 and over the spreader bars 118. In some embodiments, a piston cylinder 124 used to outwardly spread the spreader bars 118 is arranged proximate to the second end 116 of the central tube 108 and connected between the central tube 108 and the spreader bars 118. In embodiments, the piston cylinder 124 is circumferentially arranged around the central tube 108 and is permitted to slide along the central tube 108. The piston cylinder 124 is coupled to the spreader bars 118 via a respective set of linkages 127. In embodiments, the piston cylinder 124 is coupled to an actuator 125 that translates a position of which the piston cylinder 124 is located along the central tube 108 for outwardly spreading and stretching the intestine fed around the central tube 108. The actuator 125 can be, but is not limited to, an electrical linear actuator or a pneumatic linear actuator.

The intestine flusher assemblies 100 and 200 can have multiple (e.g., two, more than two) spray bars 126 arranged exterior to the intestine around the central tube 108 and spreader bars 118 to spray the outside of the intestine with water and remove fecal matter as the intestine is moved onto the central tube 108 and spreader bars 118. The spray bars 126 can include spray nozzles 128 and can oscillate. For example, the spray nozzles 128 can rotate about forty-three degrees (43°), with one spray nozzle 128 spraying proximate to the first end 114 of the central tube 108 and another spray nozzle 128 spraying proximate to the second end 116 of the central tube 108. Each one of the spray nozzles 128 can spray with a sixty-five-degree (65°) vee-shaped spray pattern. In embodiments, the spray bars 128 oscillate so as to oscillate the spray nozzles 128. The water sprayed onto the intestine can be used to dislodge fecal matter from the intestine.

In some embodiments, a motor 130 can drive a crank gear mechanism 132 to oscillate the spray bars 126 and spray the outside of the intestine. The crank mechanism 132 includes a crank gear 134 with a crank pin 136 located off-center from a rotational axis of the crank gear 134. A rocker rod 138 is coupled to the crank pin 136 and drives a rocker arm 140, which is further coupled to a master sprocket 142. The master sprocket 140 drives multiple follower sprockets 144 (via drive chain 146), which correspond to and oscillate the multiple spray bars 126. In some embodiments, the motor 130 can be a one-half (½) horsepower four hundred and eighty volt (480 V) three-phase sixty hertz (60 Hz) stainless steel sanitary motor, with a sixty-to-one (60:1) stainless steel gear reducer. Water usage for the spray bars 126 may be about fifteen gallons per minute (15 gpm) at about ninety pounds per square inch gauge pressure (90 psig).

In embodiments, water is supplied from a high-pressure water source 148 to an inlet 150 of a header 152 where the water is then distributed and sprayed into and onto the intestine. In embodiments, distribution of the high-pressure water is controlled by a set of electrically actuated solenoid valves or another mechanism. For example, solenoid valve 154A controls water supplied to central tube 108, solenoid valve 154B controls water supplied to the spray bars 126, and solenoid valve 154C controls water supplied to the spreader bars 118. In embodiments of the disclosure, the intestine flusher assemblies 100 and 200 can include one or more foot pedals for operating the intestine flusher assemblies 100 and 200, e.g., for directing the flow of water through the various components (e.g., central tube 108, spray bars 126, and spreader bars 126). The foot pedals can be connected to one or more control valves (e.g., the electrically actuated solenoid valves 154A-C) that turn the flow of water on and off. One or more of the foot pedals can also be used to control the spreading of the spreader bars. For example, the piston cylinder 124 arranged at the second end 116 of the central tube 108 can be controlled by an air-operated control valve. An operator can control the intestine flusher assembly by first enabling foot pedal control (e.g., via an actuation mechanism, such as a button) and then using the foot pedal(s) to control expansion of the spreader bars 126, operation of the spray nozzles 128, and so forth. For example, foot pedal control can activate the water flows and oscillation of the spray bars 126.

In some embodiments, a National Electrical Manufacturers Association (NEMA) 4× panel 156 with lockable disconnect can be used to control the intestine flusher assembly equipment. An internal control transformer can be used in the cabinet to provide one hundred and twenty volt alternating current (120 VAC) control power for the equipment. As described, the intestine flusher assembly can provide complete coverage for flushing and washing of the intestine, both inside and out, as well as facilitate semi-automatic loading of the intestine in the intestine flusher assembly.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. An intestine flusher assembly for cleaning an intestine, comprising:
a frame;
a tube coupled to the frame, the tube having a first end and an opposing second end, the first end configured to receive water, the second end configured to receive the intestine around the tube, the second end having a forward-facing nozzle for discharging the water to dislodge fecal matter within the intestine, the tube including a plurality of hinges located proximate to the second end;
a plurality of spreader bars, each spreader bar among the plurality of spreader bars having a first end and an opposing second end, the first end coupled to a respective hinge among the plurality of hinges of the tube;
an actuator coupled to the tube and proximate to the second end of each of the plurality of spreader bars, the actuator configured to selectively spread the second end of each of the plurality of spreader bars relative to the tube for spreading the intestine as the intestine is moved along the tube; and
a housing coupled to the frame, the housing for housing at least a portion of the tube and a portion of the plurality of spreader bars.

2. The intestine flusher assembly of claim 1, further comprising a plurality of rear-facing ports for discharging the water to simultaneously push the intestine along the tube and clean the interior of the intestine.

3. The intestine flusher assembly of claim 1, further comprising a plurality of spray bars configured to oscillate while spraying to wash the exterior of the intestine.

4. The intestine flusher assembly of claim 3, further comprising:
a crank gear mechanism coupled to the spray bars, the crank gear mechanism configured to oscillate the spray bars; and
a motor coupled to the crank gear mechanism for driving the crank gear mechanism to oscillate the spray bars.

5. The intestine flusher assembly of claim 1, further comprising:
a header including an inlet configured to couple to a high-pressure water source, the header in fluid communication with the tube and the plurality of spreader bars;
a first solenoid valve coupled to and therebetween the tube and the header for selective control of water supplied from the header to the tube; and
a second solenoid valve coupled to and therebetween the plurality of spreader bars and the header for selective control of water supplied from the header to the plurality of spreader bars.

6. The intestine flusher assembly of claim 3, further comprising:
a header including an inlet configured to couple to a high-pressure water source, the header in fluid communication with the tube and the plurality of spreader bars;
a first solenoid valve coupled to and therebetween the tube and the header for selective control of water supplied from the header to the tube;
a second solenoid valve coupled to and therebetween the plurality of spreader bars and the header for selective control of water supplied from the header to the plurality of spreader bars; and
a third solenoid valve coupled to and therebetween the plurality of spray bars and the header for selective control of water supplied from the header to the plurality of spray bars.

7. The intestine flusher assembly of claim 1, further comprising a piston cylinder coupled to the spreader bars and the tube, the piston cylinder located proximate to the first end of the tube, the piston cylinder permitted to translate along the tube to outwardly spread the spreader bars relative from the tube, the actuator coupled to the piston cylinder and configured to translate the piston cylinder along the tube.

8. The intestine flusher assembly of claim 1, wherein the actuator is an electrical linear actuator or a pneumatic linear actuator.

9. The intestine flusher assembly of claim 1, wherein the housing includes a removable cover for accessing equipment housed within the housing.

10. The intestine flusher assembly of claim 9, wherein the removable cover includes a transparent viewport.

11. The intestine flusher assembly of claim 3, wherein the spray bars include a plurality of spray nozzles configured to have a sixty-five-degree (65°) vee-shaped spray pattern.

12. The intestine flusher assembly of claim 3, wherein the spray bars include a plurality of spray nozzles, the plurality of spray nozzles configured to rotate up to forty-three degrees (43°).

13. The intestine flusher assembly of claim 1, wherein each spreader bar among the plurality of spreader bars includes a plurality of apertures arranged along a length of the spreader bar for discharging the water outwardly from the plurality of apertures into the intestine.

14. An intestine flusher assembly for cleaning an intestine, comprising:
a frame;
a tube coupled to the frame, the tube having a first end and an opposing second end, the first end configured to receive water, the second end having a forward-facing nozzle for discharging the water to dislodge fecal matter within the intestine, the second end having a plurality of rear-facing ports for discharging the water to push the intestine along the tube and clean the interior of the intestine, the tube including a plurality of hinges located proximate to the second end;
a plurality of spreader bars, each spreader bar among the plurality of spreader bars having a first end and an opposing second end, the first end coupled to a respective hinge among the plurality of hinges of the tube, each spreader bar among the plurality of spreader bars including a plurality of apertures arranged along a length of the spreader bar for discharging water outwardly from the plurality of apertures and into the intestine;
a piston cylinder coupled to the spreader bars and the tube, the piston cylinder located proximate to the first end of the tube, the piston cylinder permitted to translate along the tube to spread the spreader bars relative to the tube to spread and stretch the intestine as it is fed around the tube and the spreader bars;
an actuator coupled to the tube and the piston cylinder, the actuator configured to translate the piston cylinder along the tube;
a plurality of spray bars coupled to the frame, the plurality of spray bars configured to oscillate while spraying to wash the exterior of the intestine;
a header including an inlet configured to couple to a high-pressure water source, the header in fluid communication with the tube, the plurality of spreader bars, and the plurality of spray bars;
a first solenoid valve coupled to and therebetween the tube and the header for selective control of water supplied from the header to the tube;
a second solenoid valve coupled to and therebetween the plurality of spreader bars and the header for selective control of water supplied from the header to the plurality of spreader bars; and
a third solenoid valve coupled to and therebetween the plurality of spray bars and the header for selective control of water supplied from the header to the plurality of spray bars.

15. The intestine flusher assembly of claim 14, further comprising a housing coupled to the frame for housing the plurality of spray bars, the housing at least partially enclosing the tube and the plurality of spreader bars, the housing including a removable cover for accessing equipment housed within the housing, wherein the removable cover includes a transparent viewport.

16. An intestine flusher assembly for cleaning an intestine, comprising:
a frame;
a tube coupled to the frame, the tube having a first end and an opposing second end, the first end configured to receive water, the second end configured to receive the intestine around the tube, the second end having a forward-facing nozzle for discharging the water to dislodge fecal matter within the intestine, the second end having a plurality of rear-facing ports for discharging the water to push the intestine along the tube and clean the interior of the intestine, the tube including a plurality of hinges located proximate to the second end;
a plurality of spreader bars, each spreader bar among the plurality of spreader bars having a first end and an opposing second end, the first end coupled to a respective hinge among the plurality of hinges of the tube;
an actuator coupled to the tube and proximate to the second end of each of the plurality of spreader bars, the actuator configured to selectively spread the second end of each of the plurality of spreader bars relative to the tube for spreading the intestine as the intestine is moved along the tube;
a plurality of spray bars coupled to the frame, the plurality of spray bars configured to oscillate while spraying to wash the exterior of the intestine; and
a header including an inlet configured to couple to a high-pressure water source, the header in fluid communication with the tube, the plurality of spreader bars, and the plurality of spray bars.

17. The intestine flusher assembly of claim 16, wherein each spreader bar among the plurality of spreader bars includes a plurality of apertures arranged along a length of the spreader bar for discharging the water outwardly from the plurality of apertures into the intestine.

18. The intestine flusher assembly of claim 16, wherein each spreader bar among the plurality of spreader bars includes a plurality of apertures arranged along a length of the spreader bar for discharging the water outwardly from the plurality of apertures into the intestine.

19. The intestine flusher assembly of claim 16, further comprising:
a crank gear mechanism coupled to the spray bars, the crank gear mechanism configured to oscillate the spray bars; and
a motor coupled to the crank gear mechanism for driving the crank gear mechanism to oscillate the spray bars.

20. The intestine flusher assembly of claim 16, further comprising a piston cylinder coupled to the spreader bars and the tube, the piston cylinder located proximate to the first end of the tube, the piston cylinder permitted to translate along the tube to outwardly spread the spreader bars relative from the tube, the actuator coupled to the piston cylinder and configured to translate the piston cylinder along the tube.
